(19) United States
(12) Patent Application Publication
(10) Pub. No.: US 2008/0202228 A1
(43) Pub. Date: Aug. 28, 2008

(54) Cylinder Lift Detection Device for Compressed Air Disc Brakes

(76) Inventors: Robert A Emmett, York (GB); Wilfried Strauss, Wald-Michelbach (DE)

Correspondence Address: Robert L Stearns;Howard & Howard Attorneys, 39400 Woodward Avenue, Suite 101, Bloomfield Hills, MI, 48304-5151, US

(21) Appl. No.: 10/559,565

(22) PCT Filed: Mar. 11, 2004
(86) PCT No.: PCT/EP04/03033

§ 371 Date: Mar. 19, 2008

(30) Foreign Application Priority Data
Jun. 5, 2003 (DE) 10325596.6

(51) Int. Cl. G01L 5/28

(52) U.S. Cl. 73/121

(57) ABSTRACT

A cylinder lift detection device for compressed-air disk brakes includes a sensor for detecting the cylinder lift, a power source for feeding the sensor, an actuating device which is mounted between the sensor and the power source and is used to switch on the sensor, and a functional display that is connected to the sensor and displays the operative or defective state of the brakes.

### BACKGROUND OF THE INVENTION

1. Technical Field

The present invention relates to a cylinder lift detection device for compressed air disc brakes and more generally to a detection device for the cylinder lift in all brakes in which the cylinder is screwed directly onto the brakes.

2. Related Art

In drum brakes and in disc brakes, it was previously possible to measure the lift of the external lever after a pressurization, and thus to test whether the brake still worked properly. In newer compressed air brake, now available on the market, this is still possible only if the standard cylinder is replaced by a special detection cylinder. This would entail a high servicing cost, for which reason such cylinder lift tests are no longer carried out.

### SUMMARY OF THE INVENTION

The present invention provides a cylinder lift detection device, which may be inserted as a separate device during servicing of the vehicle for the simple and quick testing of brake function.

The cylinder lift detection device for compressed air brakes includes a sensor for the detection of the cylinder lift, a power source that supplies the sensor, an activation device connected between the sensor and the power source, with which the sensor can be switched on, and a function indicator that is connected to the sensor, which indicates the proper or defective condition of the brake.

With the detection device pursuant to the invention, a separate device or a supplement to a system already built into a vehicle are possible. With the detection device pursuant to the invention, after activation of the activation device, the sensor may be supplied with power, and thus ready for operation. If the cylinder lift is within the normal working range, the sensor will not respond, and the proper functioning is indicated by the function indicator. If, on the other hand, the lift is too great and is outside the bounds of the function range, the sensor responds and activates the indicator for the defective condition in the function indicator.

It is preferable that the components, with the exception of the sensor, be housed inside a casing. The sensor is preferably to be connected to the casing with a cable. In this way, the sensor may be operated as an external sensor and can also be more comfortable positioned on inaccessible places in the brakes.

The sensor is preferably a pressure sensor. This embodiment is preferred, if there is a change in pressure during a lift.

Alternatively, the sensor may work with ultrasound. This embodiment is preferred if the change in lift can be measured with ultrasound in a venting hole from the cylinder.

The sensor is preferably adapted so that it may be attached in a venting hole of the cylinder. Thus, it may possibly be arranged next to the venting hole, on the venting hole and even inside the venting hole.

Preferably, the indicator provided is continuous, connected to the sensor and measures the cylinder lift continuously. This additional indicator allows the continuing visual control of the lift and represents an additional function, besides that of the function indicator, that is desirable in servicing.

### THE DRAWINGS

Additional advantages, characteristics and application possibilities of this invention may be seen from the following description of an embodiment in connection with the drawing in which:

FIG. 1 shows schematically an embodiment of the cylinder lift detection device pursuant to the invention.

### DETAILED DESCRIPTION

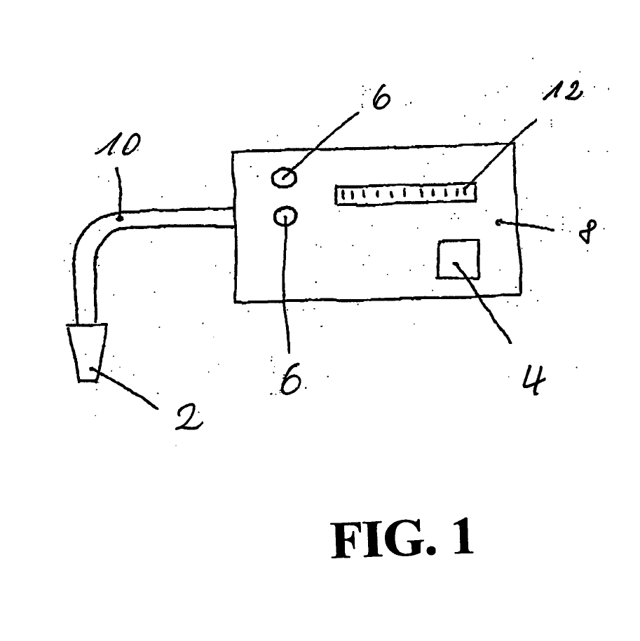

A cylinder lift detection device shown in FIG. 1 serves to measure a cylinder lift of an activation cylinder, that is either screwed or mounted onto a compressed air disc brake. The detection device includes a sensor 2, which may be mounted on a venting hole (not shown) of an activation cylinder (not shown). The sensor works as a pressure sensor or as an ultrasound sensor. The sensor is connected by means of a cable 10 with a casing 8, in which the components of the detection device are housed. In the casing 8 a power source in the form of a battery is provided, which is connected with the cable 10 and supplies the sensor with its line voltage. Furthermore, there is a return wire provided in the cable, that is connected to an indicator 6 in the form of a red LED and a green LED.

As long as the cylinder lift is within the normal working range, the cylinder piston moves only up to a position in front of the venting holes. In this case, the sensor causes the green LED in the casing to light up. If, on the other hand, the lift is greater than the axial position of the venting holes, the piston closes the hole, and the sensor causes the red LED to light up. Additionally, between the cable 10 and the power source (not shown) there is an activation device 4 in the form of an operator's button, which serves to admit the voltage to the sensor. The function button is pressed for more than five seconds in order to make the sensor ready for operation. Finally, a continual indicator 12 in the form of a connectible LED segment indicator or alternatively a dial/graduated indicator is provided in the casing, which is also connected with the cable 10 and shows the lift in millimeters. For this purpose the sensor must be one, that measures the lift continuously. Finally, an electronic processing device is provided in the casing, which is connected with the cable 10, the function indicator 6 and the continuous indicator 12, as well as with the activation device 4, and which provides an evaluation of the signal originating in the sensor for the purposes of the function indicator 6 and the continuous indicator 12.

The detection device for the lift pursuant to the invention is characterized by extreme flexibility. It may be operated in the service area of a workshop and after manual fastening of the sensor, can give an immediate indication of brake function.

Alternatively, it can be built into the vehicle, and integrated with already-existing devices for brake monitoring. For example it may be combined with a “brake alert”, in which the sensor is connected to already-existing indicator systems.

1-8. (canceled)

9. A cylinder lift detection device for compressed air disc brakes, comprising a sensor for the detection of the cylinder lift, a power source to supply the sensor with power, an activation device connected between the sensor and the power source, with which the sensor can be switched on, and a function indicator that is connected to the sensor, which indicates the proper or defective condition of the brake, and wherein the sensor comprises a continuous sensor and the function indicator is a continuous indicator which is connected to the sensor and continuously indicates the lift of the cylinder.

10. Cylinder lift detection device of claim 9, including a casing, in which the sensor is connected to the housing by a cable.

11. Cylinder lift detection device of claim 9, wherein the sensor comprises a pressure sensor.

12. Cylinder lift detection device of claim 9, wherein the sensor is an ultrasonic sensor.

13. Cylinder lift detection device of claim 9, wherein the sensor is attachable to a venting hole of the cylinder.

14. Cylinder lift detection device of claim 9, wherein the indicator comprises an LED segment indicator that shows the lift in millimeters.

15. Cylinder lift detection device of claim 9, wherein the indicator is provided as a dial or graduated indicator that shows the lift in millimeters.

16. Cylinder lift detection device of claim 10, including an electronic processing unit in the casing, which is connected with the cable, the indicator and the activation device and which is operative to provide an evaluation of the signal originating in the sensor for the indicator.
